(19) United States
(12) Patent Application Publication
(10) Pub. No.: US 2024/0083173 A1
(43) Pub. Date: Mar. 14, 2024

(54) LIQUID EJECTION APPARATUS, IMPRINT APPARATUS, AND EJECTION METHOD

(71) Applicant: CANON KABUSHIKI KAISHA, Tokyo (JP)

(72) Inventor: YUTAKA MITA, Tochigi (JP)

(21) Appl. No.: 18/456,588

(22) Filed: Aug. 28, 2023

(30) Foreign Application Priority Data
Sep. 8, 2022 (JP) 2022-143168

(51) Int. Cl. B41J 2/175; B41J 2/14; B41J 2/19

(52) U.S. Cl. CPC B41J 2/175; B41J 2/14201; B41J 2/19

(57) ABSTRACT

Provided are a liquid ejection apparatus, an imprint apparatus, and an ejection method capable of obtaining a favorable ejection state. To this end, in the course of use of an ejection material, a water head difference (reference height) between an ejection port face and a liquid surface of a hydraulic fluid 35 in a sub tank 26 is changed.

### BACKGROUND OF THE INVENTION

### Field of the Invention

The present invention relates to a liquid ejection apparatus, an imprint apparatus, and an ejection method for ejecting a liquid.

### Description of the Related Art

There is a liquid ejection apparatus that ejects a liquid stored in a storage container from an ejection head. Japanese Patent Laid-Open No. 2008-105360 describes a structure in which the interior of a sub tank communicating with an ejection head is divided into an ink chamber and a buoyancy generation chamber by a flexible member in order to keep the pressure in the sub tank at negative pressure. In the buoyancy generation chamber, a float bag having a small specific gravity is attached in conjunction with the flexible member. Japanese Patent Laid-Open No. 2008-105360 describes a technique for keeping the negative pressure in the ejection head communicating with the ink chamber by utilizing the buoyancy of the float bag.

In addition, Japanese Patent Laid-open No. 2016-019930 describes a structure in which a storage container includes a liquid chamber that stores an ejection liquid to be ejected from an ejection head and a liquid chamber that stores a liquid filler, and the two liquid chambers are partitioned by a flexible film. With a decrease in the ejection liquid in the storage container by ejection, the pressure in the liquid chamber storing the liquid filler changes. Japanese Patent Laid-open No. 2016-019930 describes a technique for keeping the negative pressure in the ejection head by controlling the pressure in the liquid chamber storing the liquid filler within an allowable range.

In a case where an ejection material in a storage container is consumed by ejection, a flexible member is deformed along with the consumption of the ejection material. With the occurrence of the deformation, a resistance force of the flexible member is generated and the pressure in the ink chamber changes. Then, as the ejection material is consumed, the resistance force of the flexible member increases. However, Japanese Patent Laid-open Nos. 2008-105360 and 2016-019930 do not mention anything about the resistance force of the flexible member.

With the resistance force of the flexible member taken into consideration, the pressure in the ejection head can be expressed by the following formula:

Pressure in Ejection Head=Pressure in Buoyancy Generation Chamber (Pressure in Liquid Chamber Storing Liquid Filler) (Negative Pressure A)+Resistance Force of Flexible Member (Negative Pressure B)

Since the negative pressure B is intensified with consumption of the ejection material, the pressure in the ejection head inevitably changes even if the negative pressure A is regulated to be substantially constant. As a result, the ejection performance also changes, and therefore a favorable ejection state may not be obtained.

### SUMMARY OF THE INVENTION

To address this, the present invention provides a liquid ejection apparatus, an imprint apparatus, and an ejection method capable of obtaining a favorable ejection state.

A liquid ejection apparatus of the present invention includes: an ejection head having an ejection port face in which an ejection port configured to eject an ejection material is formed; a storage container including a first storage space that stores the ejection material and communicates with the ejection head, and a second storage space that is separated from the first storage space by a flexible member and stores a hydraulic fluid; a sub tank that communicates with the second storage space and is capable of supplying the hydraulic fluid to the second storage space; a main tank that is capable of supplying the hydraulic fluid to the sub tank, in which the ejection port face is arranged at a position higher than a liquid surface of the hydraulic fluid in the sub tank; and a water head difference change unit that changes heights of the ejection port face and the liquid surface of the hydraulic fluid in the sub tank along with ejection of the ejection material from the ejection port.

According to the present invention, it is possible to provide a liquid ejection apparatus, an imprint apparatus, and an ejection method capable of obtaining a favorable ejection state.

Further features of the present invention will become apparent from the following description of exemplary embodiments with reference to the attached drawings.

### BRIEF DESCRIPTION OF THE DRAWINGS

FIG. 1 is a schematic diagram illustrating an imprint apparatus;

FIG. 2 is a schematic structural diagram illustrating an ejection unit functioning as a liquid ejection apparatus;

FIG. 3 is an enlarged view of an area around ejection ports in an ejection head;

FIG. 4 is a chart of a characteristic curve of a negative pressure generated in a first storage space;

FIG. 5 is a diagram illustrating a cleaning step of the first storage space and a first film;

FIG. 6 is a chart of a characteristic curve of a negative pressure generated in the first storage space;

FIG. 7A is a chart of a characteristic curve of a negative pressure generated in the first storage space;

FIG. 7B is a diagram presenting a reference height table;

FIG. 8A is a chart of a characteristic curve of a negative pressure generated in the first storage space; and

FIG. 8B is a diagram presenting a reference height table.

### DESCRIPTION OF THE EMBODIMENTS

### First Embodiment

Hereinafter, a first embodiment of the present invention will be described with reference to the drawings.

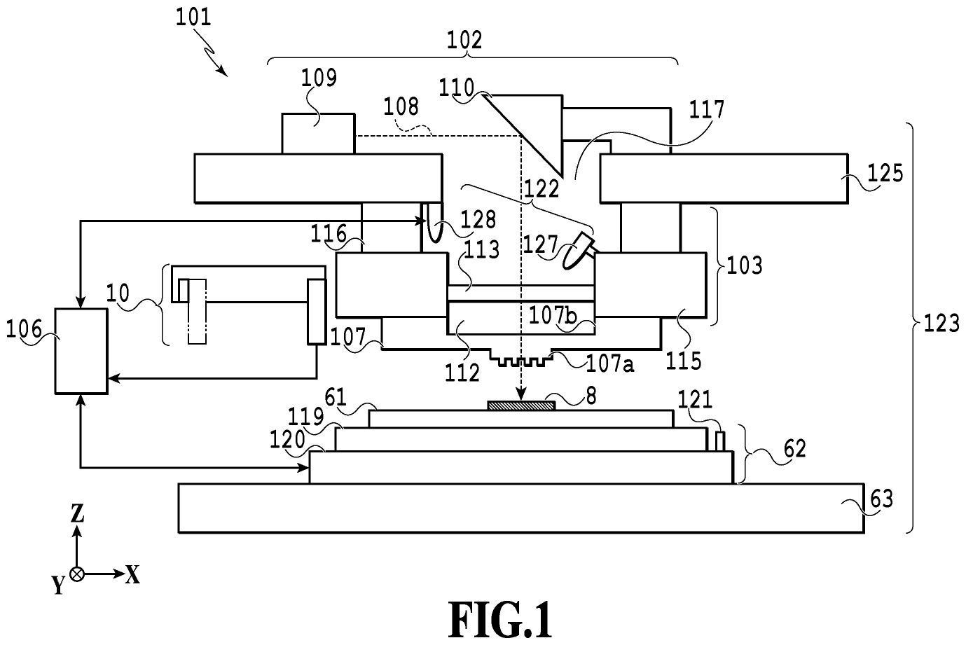

FIG. 1 is a schematic diagram illustrating a structure of an imprint apparatus 101 applicable to the present embodiment. The imprint apparatus 101 is used to manufacture various devices such as semiconductor devices. The imprint apparatus 101 includes an ejection unit 10. The ejection unit 10 ejects an ejection material 8 (resist) onto a medium 61. The ejection material 8 is a photocurable resin having a property of being cured by receiving ultraviolet rays 108. The ejection material 8 is selected as appropriate depending on various conditions in a semiconductor device manufacturing process and the like. Besides the photocurable resin, for example, an ejection material of a thermosetting resist may be used. In this case, the imprint apparatus may be an apparatus that performs imprint processing by curing the resist with heat. The ejection material 8 may be also referred to as an imprint material.

The imprint apparatus 101 performs imprint processing including the following series of processes. Specifically, the imprint apparatus 101 causes the ejection unit 10 to eject the ejection material 8 onto the medium 61. Then, the imprint apparatus 101 presses a mold 107 having a pattern for molding against the ejection material 8 ejected on the medium 61, and cures the ejection material 8 in that state by irradiation with light (ultraviolet rays). After that, the mold 107 is separated from the cured ejection material 8, and thereby the pattern of the mold 107 is transferred onto the medium 61.

The imprint apparatus 101 includes a light irradiation unit 102, a mold holding mechanism 103, a conveyance unit 62, the ejection unit 10, a control unit 106, a measurement unit 122, and a housing 123.

The light irradiation unit 102 includes a light source 109 and an optical element 110 for correcting the ultraviolet rays 108 emitted by the light source 109. The light source 109 is, for example, a halogen lamp that generates i-line or g-line. The ejection material 8 is irradiated with the ultraviolet rays 108 through the mold (die) 107. The wavelength of the ultraviolet rays 108 is a wavelength depending on the ejection material 8 to be cured. Here, in the case of the imprint apparatus using a thermosetting resist as the resist, a heat source unit for curing the thermosetting resist is provided in place of the light irradiation unit 102.

The mold holding mechanism 103 includes a mold chuck 115 and a mold drive mechanism 116. The mold 107 held by the mold holding mechanism 103 has a rectangular outer peripheral shape and includes a pattern section 107a on its surface to face the medium 61. In the pattern section 107a, an uneven pattern such as a circuit pattern to be transferred is three-dimensionally formed. As a material for the mold 107 in the present embodiment, a material through which the ultraviolet rays 108 can pass, for example, quartz is used.

The mold chuck 115 holds the mold 107 with vacuum adsorption or electrostatic force. The mold drive mechanism 116 moves the mold 107 by holding and moving the mold chuck 115. The mold drive mechanism 116 is capable of pressing the mold 107 against the ejection material 8 by moving the mold 107 in a −Z direction. In addition, the mold drive mechanism 116 is capable of separating the mold 107 from the ejection material 8 by moving the mold 107 in a +Z direction. An example of an actuator employable in the mold drive mechanism 116 is a linear motor or an air cylinder.

The mold chuck 115 and the mold drive mechanism 116 have an opening area 117 in their center portions. The mold 107 has a cavity 107b in a recessed shape on its surface to be irradiated with the ultraviolet rays 108. A light transmission member 113 is installed in the opening area 117 of the mold drive mechanism 116, so that a sealed space 112 surrounded by the light transmission member 113, the cavity 107b, and the opening area 117 is formed. The pressure in the space 112 is controlled by a pressure correction device (not illustrated). In the case where the pressure correction device sets the pressure in the space 112 to be higher than in the outside, the pattern section 107a is bent in a shape convex to the medium 61. Thus, a center portion of the pattern section 107a comes into contact with the ejection material 8. As a result, in the course of pressing the mold 107 against the ejection material 8, a gas (air) is inhibited from being trapped between the pattern section 107a and the ejection material 8, and the uneven portions in the pattern section 107a can be all over filled with the ejection material 8. The depth of the cavity 107b that determines the size of the space 112 is changed as appropriate depending on the size or material of the mold 107.

The conveyance unit 62 includes a substrate chuck 119, a substrate stage housing 120, and a stage reference mark 121. The medium 61 held by a substrate stage is a single crystal silicon substrate or a silicon on insulator (SOI) substrate, and the ejection material 8 is ejected onto a treatment-target surface of the medium 61 to form a pattern.

The substrate chuck 119 holds the medium 61 with vacuum adsorption. The substrate stage housing 120 moves the medium 61 by holding the substrate chuck 119 with a mechanical unit and moving the substrate chuck 119 in an X direction and a Y direction. The stage reference mark 121 is used to set a reference position for the medium 61 in the alignment of the medium 61 and the mold 107.

As an actuator for the substrate stage housing 120, for example, a linear motor is used. Besides, the actuator for the substrate stage housing 120 may have a structure including multiple drive systems such as a coarse drive system and a fine drive system.

The ejection unit 10 ejects the uncured ejection material 8 in a liquid state from nozzles, and thereby applies the ejection material 8 onto the medium 61. The present embodiment employs a method in which the ejection material 8 is pushed out from each ejection port by using a piezoelectric effect of a piezo element. The control unit 106 to be described later generates a driving waveform for driving each piezo element to apply the driving waveform to the piezo element, and drives the piezo element so that the piezo element is deformed into a shape suitable for ejection. Multiple nozzles are provided and are each controllable independently. The amount of the ejection material 8 to be ejected from the nozzles of the ejection unit 10 is determined as appropriate depending on a desired thickness of the ejection material 8 to be formed on the medium 61, the density in the pattern to be formed on the medium 61, and so on.

The measurement unit 122 includes an alignment meter 127 and an observation meter 128. The alignment meter 127 measures misalignments in the X direction and the Y direction between the alignment mark formed on the medium 61 and the alignment mark formed on the mold 107. The observation meter 128 is an imaging device such, for example, as a CCD camera, captures an image of the pattern of the ejection material 8 ejected on the medium 61, and outputs the captured image as image information to the control unit 106.

The control unit 106 controls operations of all the constituent elements of the imprint apparatus 101. The control unit 106 is composed of, for example, a computer including a CPU, a ROM, and a RAM. The control unit 106 is connected to all the constituent elements of the imprint apparatus 101 via lines, and the CPU controls all the constituent elements in accordance with a control program stored in the ROM.

The control unit 106 controls the operations of the mold holding mechanism 103, the conveyance unit 62, and the ejection unit 10 based on measurement information of the measurement unit 122. Here, the control unit 106 may be configured integrally with the other units in the imprint apparatus 101 or may be implemented as an apparatus different from the imprint apparatus 101. In addition, the control unit 106 may be composed of multiple computers instead of a single computer.

The housing 123 includes a base plate 63 on which the conveyance unit 62 is mounted, a bridge surface plate 125 that fixes the mold holding mechanism 103, and columns 126 (not illustrated) that extend from the base plate 63 and support the bridge surface plate 125.

The imprint apparatus 101 includes a mold conveyance mechanism (not illustrated) that conveys the mold 107 from the outside of the apparatus to the mold holding mechanism 103 and a substrate conveyance mechanism (not illustrated) that conveys the medium 61 from the outside of the apparatus to the conveyance unit 62.

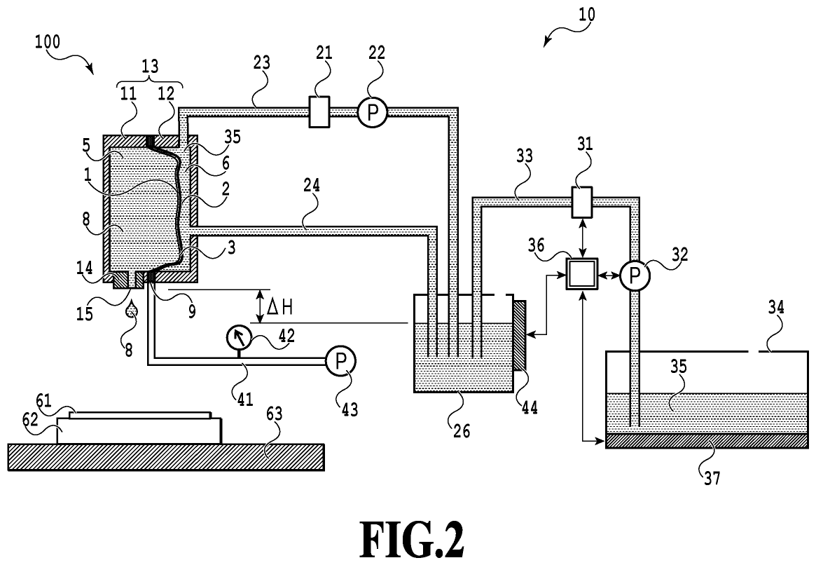

FIG. 2 is a schematic structural diagram illustrating a liquid ejection unit 10 functioning as a liquid ejection apparatus. The liquid ejection unit (hereinafter also referred to as the liquid ejection apparatus) 10 includes a main tank 34 that communicates with the atmosphere and stores therein a hydraulic fluid 35, and a sub tank 26 that communicates with the atmosphere, is allowed to communicate with the main tank 34, and stores therein the hydraulic fluid 35. Further, the liquid ejection apparatus 10 includes an ejection material storage unit 100 that communicates with the sub tank 26.

The ejection material storage unit 100 includes a storage container 13 that stores the ejection material 8 and an ejection head 14 attached to the storage container 13. Here, the storage container 13 and the ejection head 14 may be configured as separate units or may be integrated as a single unit. The storage container 13 may be of a cartridge type. The ejection head 14 is capable of ejecting the ejection material 8 from ejection ports 15 opened in an outer surface (ejection face) of the ejection head. In the present embodiment, the ejection ports 15 are arranged at a density of 500 to 1000 per inch in the ejection face of the ejection head 14.

In the liquid ejection apparatus 10, the conveyance unit 62 mounted on the base plate 63 is arranged to face the ejection face of the ejection head 14. The conveyance unit 62 is capable of moving the medium 61 as an application target of the ejection material 8 relative to the ejection head 14 by moving on the base plate 63 while adsorbing and holding the medium 61 by use of an adsorption unit not illustrated. The ejection material 8 stored in the storage container 13 is ejected from the ejection ports 15 of the ejection head 14 to an ejection material application area of the medium 61 conveyed to a position facing the ejection ports 15. In this way, a desired ejection material pattern (for example, a printed image) is formed.

The ejection material 8 is, for example, a liquid or a liquid-like substance. The ejection material 8 is a substance that has a fluidity without having a fixed shape unlike a solid during storage in the storage container 13 or ejection from the ejection head 14, and that does not undergo a great volume change as in a gas. The ejection material 8 may be a paste-like substance or a substance such as a polymer material. As the ejection material 8 in the present embodiment, an ink may be used. Non-limiting examples of the ink include various inks such as inks for image printing, conductive inks for electronic circuit manufacturing, and UV curable inks. Examples of the conductive inks include inks containing metal particles, particularly, metal nanoinks in each of which metal nanoparticles of several to several tens of nm are dispersed in a liquid.

An example of the metal nanoinks is a silver nanoink. In addition, an example of the ejection material 8 is an imprint material. For a manufacturing process of semiconductor devices or the like, there is a so-called imprint technique for forming a pattern by bringing a patterned mold (die) into contact with an imprint material on a substrate, and thereby transferring the shape of the mold to the imprint material. As the imprint material, a resist made of a photocurable resin, a thermosetting resin, or the like is used. The ejection material 8 as described above is stored in a first storage space 5 in the storage container 13.

Since the allowable size of foreign substances and the allowable content of metal ions are smaller in the imprint material than in a normal liquid, the imprint material is required to be ejected while keeping a high level of cleanliness. Therefore, it is desirable that the imprint material, which is managed in an initial stage and sealed in the storage container 13, be consumed in a state where the imprint material is kept out of contact with the outside or with devices such as a pressure sensor and the like, thereby suppressing increases in foreign substances and metal ions.

The hydraulic fluid 35 is an incompressible substance whose density (volume) change due to the outside temperature and pressure is so small as to be negligible as compared with gas. For this reason, the volume of the hydraulic fluid 35 hardly changes even if the ambient temperature or ambient pressure around the ejection apparatus changes. As the hydraulic fluid 35, for example, a substance selected from liquids such as water and gel-like substances can be used. In general, a difference between the density of the ejection material 8 and the density of the hydraulic fluid 35 is smaller than a difference between the density of the ejection material 8 and the density of gas.

In the case where the liquid ejection apparatus 10 is used as an ink ejection apparatus of a printing apparatus, an ink is naturally used as the ejection material 8, while, as the hydraulic fluid 35, an expensive ink does not have to be used but water having a specific gravity close to that of the ink can be used. More specifically, water added with an antiseptic additive in order to prevent the putrefaction of the water and the propagation of bacteria can be used as the hydraulic fluid 35. The hydraulic fluid 35 is stored in a second storage space 6 in the storage container 13.

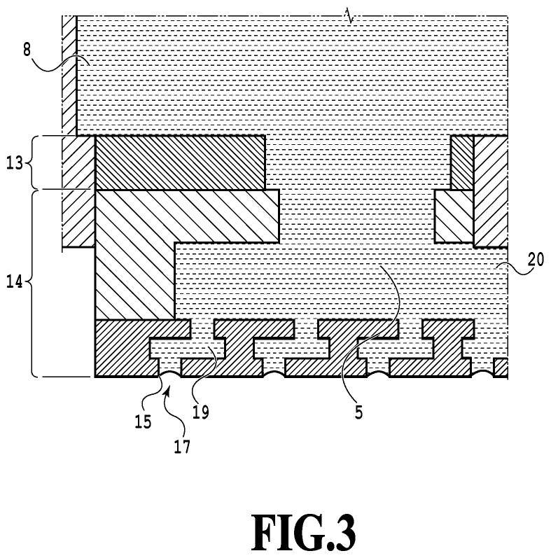

FIG. 3 is an enlarged view of an area around the ejection ports 15 in the ejection head 14. In the ejection head 14, a pressure chamber 19 provided for each of the ejection ports 15 is equipped with an actuator not illustrated. The actuator just has to generate energy capable of ejecting the ejection material 8 as fine droplets, for example, droplets of 1 pL (picoliters), and a specific example thereof is a piezo element (piezoelectric element) or a heat-generating resistance element.

In the case of using a piezo element, the influence of temperature change (temperature rise) on ejection characteristics is smaller than in the case of using a heat-generating resistance element, so the use under high temperature is possible. Therefore, a wide variety of ejection materials such as highly-viscous resins can be used. Meanwhile, in the case of using a heat-generating resistance element, the manufacturing cost may be relatively low in general. The actuator in the present embodiment is a piezo element, and the piezo element is driven and controlled to change the volume inside the pressure chamber 19 and to eject the ejection material inside the pressure chamber 19 from the ejection port 15. The piezo element may be implemented by using a micro electro mechanical system (MEMS) technique.

Each of the pressure chambers 19 communicates with a common liquid chamber 20. The common liquid chamber 20 communicates with the first storage space 5 in the storage container 13. The ejection material 8 to be ejected from the ejection ports 15 is supplied to the pressure chambers 19 from the first storage space 5 via the common liquid chamber 20. The ejection head 14 does not include any control valve between the ejection head 14 and the first storage space 5. The internal pressure in the first storage space 5 is controlled to be a negative pressure lower than the atmospheric pressure (ambient pressure) outside the ejection ports 15 of the ejection head 14. Under this negative pressure control, the ejection material 8 in each of the ejection ports 15 forms a meniscus 17 at an interface with the outside air, and is prevented from leaking (dripping) from the ejection port 15 at unintentional timing. In the present embodiment, the internal pressure in the first storage space 5 is controlled to be a negative pressure lower than the ambient pressure by 0.40±0.04 kPa.

The contour and the internal volume of the storage container 13 (see FIG. 2) are defined by a housing 11 and a housing 12. A flexible member (flexible film) 3 composed of a first film 1 and a second film 2 is provided between the housing 11 and the housing 12 as a partition member that partitions the internal space in the storage container 13 in the vertical direction into the first storage space 5 and the second storage space 6. The flexible member 3 has a multilayer structure including a film layered structure. Each of the first and second films is a thin film with a thickness of 10 to 100 μm.

The housing 11 includes a first opening opened on the side facing the housing 12 and a second opening opened on the side facing the ejection head 14. The first opening opened on the side facing the housing 12 is entirely covered and sealed with the first film 1 and the first storage space 5 is formed between the inner surface of the housing 11 and the first film 1. The second opening communicates with the common liquid chamber 20 of the ejection head 14, so that the first storage space 5 communicates with the outside space via the ejection head 14. The first storage space 5 is filled with the ejection material 8 and the interfaces between the ejection material 8 and the outside air are positioned inside the ejection ports 15 as illustrated in FIG. 3.

Returning to FIG. 2, the housing 12 has an opening opened on the side facing the housing 11. This opening is entirely covered and sealed with the second film 2, and the second storage space 6 is formed between the inner surface of the housing 12 and the second film 2. The second storage space 6 is filled with the hydraulic fluid 35. The second storage space 6 is configured to communicate with the inside of the sub tank 26 via a pipe 24 and be allowed to communicate with the inside of the sub tank 26 via a pipe 23 including a control valve 21 and a pump 22. The sub tank 26 is a liquid storage unit for storing the hydraulic fluid 35 and is configured to be able to supply the hydraulic fluid 35 to the second storage space 6 with which the sub tank 26 communicates. The hydraulic fluid 35 functions as a liquid filler in the second storage space 6. The first film 1 and the second film 2 each function as a partition wall between the first storage space 5 and the second storage space 6.

A film material for use in the first film 1 and the second film 2 may be any material resistant to the ejection material 8 and the hydraulic fluid 35 from the viewpoint of wettability or the like. For example, Teflon (registered trademark)-based fluororesins may be used such as tetrafluoroethylene-perfluoroalkyl vinyl ether copolymer (PFA), ethylenetetrafluoroethylene (ETFE), and polytetrafluoroethylene (PTFE). Further examples thereof include polyamide synthetic resins such as polyethylene (PE), polyvinyl chloride (PVC), polyethylene terephthalate (PET), polyvinyl alcohol (PVAL), polyvinylidene chloride (PVDC), and nylon. The first film 1 and the second film 2 may be made of the same material (material type and thickness) or different materials. For example, a material such as PFA resistant to the ejection material 8 may be used for the first film 1, while a nylon-based material resistant to the hydraulic fluid 35 may be used for the second film 2.

An inter-film plate 9 is provided between the first film 1 and the second film 2. The inter-film plate 9 is provided with a through hole communicating with an inter-film gap between the first film 1 and the second film 2 and is connected to an inter-film discharge pipe 41 in a communicating state. The pressure in the inter-film gap is monitored by a pressure sensor 42 in the middle of piping where the inter-film discharge pipe 41 and a negative-pressure generating member 43 are connected, and is controlled so as to be a desired negative pressure that is equal to or lower than the pressures in the first storage space 5 and the second storage space 6. Specifically, the pressure in the inter-film gap is desirably a pressure lower than the internal pressure in the first storage space 5, and is controlled so as to be a constant negative pressure selected from a pressure range from −5 kPa to −30 kPa.

Every time an internal pressure difference between the first storage space 5 and the second storage space 6 occurs, the flexible first film 1 and the flexible second film 2 together repeat movements of moving to a lower pressure side and ideally stopping moving in response to disappearance of the internal pressure difference. Therefore, the internal pressures in the first storage space 5 and the second storage space 6 can be kept substantially equal to each other.

The conditions inside the storage container 13 will be described in more details. With ejection of the ejection material 8 from the ejection head 14, the volume of the ejection material 8 is reduced by the ejected ejection material 8 and accordingly the internal pressure in the first storage space 5 decreases. At this time, the internal pressure in the second storage space 6 is higher than the internal pressure in the first storage space 5. With the negative-pressure generating member 43, the flexible first film 1 and the flexible second film 2 form, as the internal pressure in the inter-film gap, a negative pressure lower than the internal pressure in the first storage space 5. For this reason, in response to the decrease in the internal pressure in the first storage space 5, the first film 1 and the second film 2 move together to the first storage space 5 side. At the same time, the hydraulic fluid 35 is sucked into the second storage space 6 from the sub tank 26 through the pipe 24. As a result, the internal pressures in the first storage space 5 and the second storage space 6 ideally become substantially equal and are equilibrated with each other again.

As illustrated in FIG. 2, the sub tank 26 communicates with the outside space via the pipe 24, and has the internal pressure equal to the atmospheric pressure. The pipe 24 through which the inside of the sub tank 26 and the second storage space 6 communicate with each other is filled with the hydraulic fluid 35 and a liquid surface position of the hydraulic fluid 35 in the sub tank 26 in the vertical direction (hereinafter also referred to as a “liquid surface height”) is set to a position lower than the ejection ports 15 of the ejection head 14. A difference between the liquid surface position of the hydraulic fluid 35 in the sub tank 26 and the position of the ejection face in which the ejection ports 15 are opened (the distance in the vertical direction) is denoted by ΔH. In the present embodiment, the difference ΔH is set so as to maintain a state where the menisci 17 of the ejection material 8 are formed in the ejection ports 15 (the state illustrated in FIG. 3). In other words, the difference ΔH is set so that the ejection material 8 may not leak or drip from the ejection ports 15 to the outside, or the menisci 17 may not excessively retract into an inner part (for example, to the vicinity of the common liquid chamber). Specifically, the height difference ΔH is set to 40±4 mm so that the internal pressure in the first storage space 5 may be controlled to be a value lower than the ambient pressure by 0.40±0.04 kPa.

The height difference ΔH may be set as appropriate. The present embodiment is the ejection apparatus applicable to a printing apparatus capable of ejecting a liquid amount of about 1 pL or smaller, as described above. For example, in the case where the ejection material 8 is an ink for image printing, the diameter of the ejection ports 15 is a diameter of about 10 μm (micrometers). In addition, in the present embodiment, the ejection material 8 and the hydraulic fluid 35 each have a density approximately equal to that of water. In the present embodiment, the height difference ΔH is set within the above range of 40 mm±4 mm in order to form the menisci 17 of the ejection material 8 in the ejection ports 15 under these conditions. Here, for example, the diameter of the ejection ports 15 in a printing apparatus having a low resolution is several tens of and the diameter of the ejection ports in a 3D printer using a resin or the like as the ejection material 8 is several hundreds of Thus, the diameter of the ejection ports 15 differs among apparatus models to each of which the liquid ejection apparatus is applied and the physical properties of the ejection material 8 (for example, density, viscosity, and so on) also differ among them. For this reason, the height difference ΔH (reference height) is set as appropriate depending on a target to which the ejection apparatus is to be applied, in view of influences of gravity, capillary force, surface tension, and so on.

In the present embodiment, a correction operation is executed in a case where the liquid surface height of the hydraulic fluid 35 in the sub tank 26 falls outside a predetermined range with respect to a reference liquid surface height (reference height). In the above example, the correction operation is executed in a case where the liquid surface height of the hydraulic fluid 35 in the sub tank 26 falls outside the predetermined range (±4 mm of the reference liquid surface height) with respect to the reference liquid surface height (the position lower than the ejection ports 15 by 40 mm). The correction operation is a “liquid surface adjustment” operation of adjusting the liquid surface height of the hydraulic fluid 35 in the sub tank 26 to the predetermined range by moving the hydraulic fluid 35 between the main tank 34 and the sub tank 26.

In the sub tank 26, a liquid surface sensor 44 (liquid surface detection unit) is provided. The liquid surface sensor 44 in the present embodiment is capable of detecting the liquid surface height and its change (positional change) of the hydraulic fluid 35 in the sub tank 26. The main tank 34 and the sub tank 26 are allowed to communicate with each other through a pipe 33 including a control valve 31 and a pump 32. With a control unit 36, the liquid ejection apparatus 10 drives the control valve 31 and the pump 32, and thereby controls the liquid surface height of the hydraulic fluid 35 in the sub tank 26 within the desired range (liquid surface adjustment). Specifically, in a case where the liquid surface sensor 44 detects that the liquid surface height of the hydraulic fluid 35 in the sub tank 26 falls below the predetermined range, the control valve 31 is opened and the pump 32 is driven to supply the hydraulic fluid 35 from the main tank 34 to the sub tank 26.

Meanwhile, in a case where the liquid surface sensor 44 detects that the liquid surface height of the hydraulic fluid 35 in the sub tank 26 falls within the predetermined range, the supply of the hydraulic fluid 35 from the main tank 34 to the sub tank 26 is stopped by stopping the driving of the pump 32 and closing the control valve 31. In addition, the hydraulic fluid 35 can be also returned from the sub tank 26 to the main tank 34 by controlling the control valve 31 and the pump 32. In this way, the liquid surface height in the sub tank 26 is kept within the predetermined range.

A weighing scale 37 for measuring a change in weight of the hydraulic fluid 35 in the main tank 34 is arranged under the main tank 34. The control unit 36 obtains the amount of the ejection material 8 ejected from the ejection ports 15 of the ejection head 14 based on a measurement result of the weighing scale 37. Instead of the structure provided with the weighing scale 37, the control unit 36 may calculate the remaining amount of the ejection material 8 in the first storage space 5 by obtaining a cumulative value of the amount of liquid transferred by the pump 32. In the case where the remaining amount of the ejection material 8 reaches a reference amount, the control unit 36 notifies a user of the arrival of a replacement time of the storage container 13 by displaying a message or issuing an alarm for prompting replacement of the storage container 13. As a result, it is possible to prevent the liquid ejection apparatus from stopping due to a shortage of the ejection material 8 in the first storage space 5.

The sub tank 26 is preferably arranged so that its internal ceiling surface (the uppermost portion in the vertical direction) is lower than the ejection ports 15 of the ejection head 14 in the vertical direction. With this arrangement, even if the sub tank 26 is supplied with the hydraulic fluid 35 from the main tank 34 up to a full level by the above liquid surface adjustment, the liquid surface position of the hydraulic fluid 35 in the sub tank 26 is never higher than the position of the ejection face of the ejection ports 15. Specifically, since the ceiling surface of the sub tank 26 restricts the liquid surface height of the hydraulic fluid 35 in the sub tank 26, the relative positional relationship in the vertical direction between the liquid surface of the hydraulic fluid 35 and the ejection ports 15 (high-low relationship) is maintained and the height difference ΔH never reaches 0 (zero). This makes it possible to maintain the internal pressures in the first storage space 5 and the second storage space 6 at negative pressures lower than the ambient pressure and prevent the ejection material 8 from leaking and dripping from the ejection ports 15.

The second storage space 6 and the sub tank 26 communicate with each other through the pipe 24 and are allowed to communicate with each other also through the pipe 23 including the control valve 21 and the pump 22. In the case where the storage container 13 is once detached from and then again attached to the liquid ejection apparatus 10, an air bubble may enter the pipe 24. In this case, the air bubble in the pipe 24 can be removed by opening the control valve 21 and operating the pump 22 to circulate the hydraulic fluid 35 through the pipe 24, the second storage space 6, and the pipe 23 and thereby sending the hydraulic fluid 35 to the sub tank 26. The control valve 21 is closed in the case where the pump 22 is not used and is opened in the case where the pump 22 is used.

Examples of the pump 22 and the pump 32 include syringe pumps, tube pumps, diaphragm pumps, gear pumps, and so on. However, the pump 22 and the pump 32 only have to have a function of a liquid transfer unit and are not limited to the pumps. Any liquid transfer units appropriate for the liquid ejection apparatus can be selected.

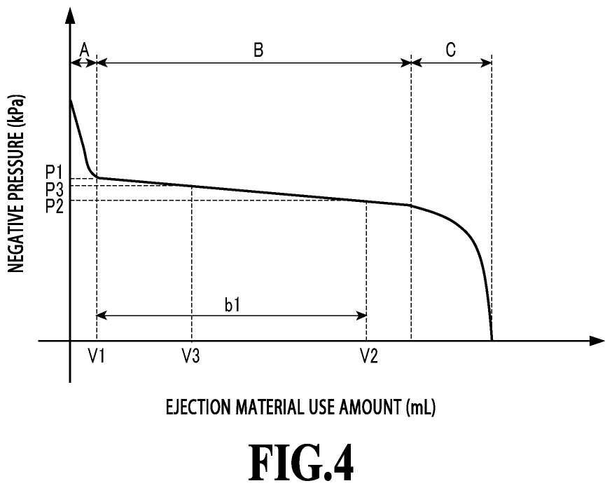

FIG. 4 is a chart of a characteristic curve of a negative pressure generated in the first storage space 5 under the condition where the height difference ΔH between the liquid surface position of the hydraulic fluid 35 in the sub tank 26 and the position of the ejection face in which the ejection ports 15 are opened is kept constant. In FIG. 4, the horizontal axis indicates a use amount of the ejection material 8 in the first storage space 5 and the vertical axis indicates an internal pressure in the first storage space 5.

The negative pressure characteristics are roughly divided into three pressure fluctuation regions A, B, and C. The pressure fluctuation region A starts from a state where a great positive pressure that is higher than a negative pressure (water head pressure) to be generated in the first storage space 5 is generated due to the difference between the liquid surface position of the hydraulic fluid 35 in the sub tank 26 and the position of the ejection face of the ejection ports 15. The pressure fluctuation region A is a region where the pressure decreases (the negative pressure intensifies) sharply in an initial stage after the start to use the ejection material 8. In the initial stage, the first storage space 5 is filled with the ejection material 8 (initial filling), the first film 1 and the second film 2 biased to the first storage space 5 side move to the second storage space 6 side, and the first film 1 and the second film 2 exert a great resistance force due to the initial deformation. For this reason, in the initial stage, the great positive pressure is temporarily generated in the first storage space 5. With ejection of the ejection material 8 (ejection for adjustment), the pressure decreases toward a pressure P1 approximately equal to the negative pressure (water head pressure).

The pressure fluctuation region B is a region where there is little change in the negative pressure along with ejection of the ejection material 8, and the pressure change relative to the use amount of the ejection material 8 exhibits a nearly linear behavior. The resistance force is small because the deformation of the first film 1 and the second film 2 gently occurs. The pressure fluctuation region C is a region where the pressure decreases (the negative pressure intensifies) sharply. The first film 1 and the second film 2 nearly complete movement to the second storage space 6 side, their movement is restricted because the volume of the second storage space 6 becomes very small, and the resistance force is great because the deformation of the first film 1 and the second film 2 is not easy.

The liquid ejection apparatus 10 adjusts the storage amount of the ejection material 8 in the first storage space 5 so that a use start timing of the ejection material can coincide with a start position V1 of a pressure fluctuation region b1. An end position V2 of the pressure fluctuation region b1 is in a range having a pressure P2 that is 0.2 kPa lower than the pressure P1 approximately equal to the negative pressure (water head pressure) to be generated in the first storage space 5 by the difference between the liquid surface position of the hydraulic fluid 35 in the sub tank 26 and the position of the ejection face of the ejection ports 15. Stable ejection may not be performed outside the range from the pressure P1 to the pressure P2 (outside the predetermined range). For this reason, it is desirable to keep the negative pressure generated in the first storage space 5 within the predetermined range from the pressure P1 to the pressure P2 and perform the ejection under the pressure in the predetermined range. Depending on a combination of the first film 1 and the second film 2, the end position V2 may be such that the pressure fluctuation region b1 extends beyond the pressure fluctuation region B and overlaps a part of the pressure fluctuation region C.

Note that the pressure P2 is not limited to the pressure 0.2 kPa lower than the pressure P1, and is preferably set as appropriate.

In a general liquid ejection apparatus that generates a negative pressure by using a water head difference, the liquid surface of the hydraulic fluid in the sub tank is fixed to a predetermined range initially adjusted. Every time the pressure falls outside the pressure fluctuation region where stable ejection is possible, the ejection container is supplemented with the ejection material regardless of the storage amount (remaining amount) in the ejection container. This method, however, does not consider the resistance force of the flexible member that deforms along with use of the ejection material and may fail in stable ejection.

Therefore, in the present embodiment, a relationship between the storage amount and a pressure P3 in the first storage space 5 including the resistance force of the flexible member is obtained in advance, and the liquid surface height of the hydraulic fluid 35 (reference height) in the sub tank 26 is changed based on the use amount of the ejection material 8 (the internal pressure in the first storage space 5). Hereinafter, this method will be described.

The liquid ejection apparatus 10 in the present embodiment calculates the storage amount (remaining amount) in the first storage space 5 from a use amount V3 of the ejection material 8 in the first storage space 5 and obtains the relationship between the storage amount and the pressure P3 in the first storage space 5 including the resistance force (deformation amount) of the flexible member in advance. The information on the relationship between the storage amount of the ejection material and the pressure in the first storage space 5 is obtained in the course of, for example, a cleaning step to remove particles adhering to the inside of the first storage space 5 and the surface of the first film 1 or the like before the liquid ejection apparatus 10 is filled with the ejection material 8.

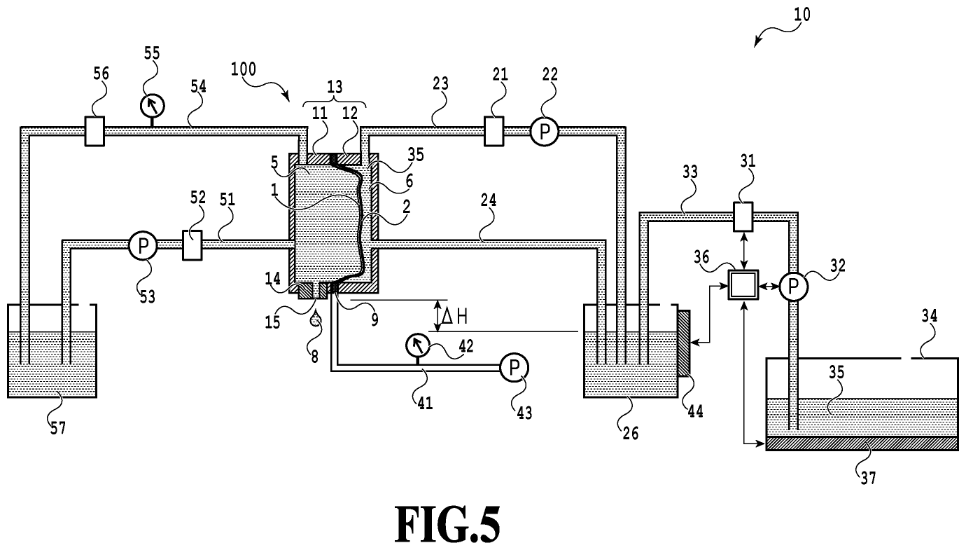

FIG. 5 is a diagram illustrating a cleaning step of the first storage space 5 and the first film 1. The housing 11 communicates with the inside of a cleaning liquid tank 57 containing a cleaning liquid through a pipe 51 and a pipe 54. A control valve 52 and a pump 53 are arranged in middle of the pipe 51. A pressure sensor 55 and a control valve 56 are arranged in the middle of the pipe 54. For supplying the cleaning liquid to the first storage space 5, the liquid in the cleaning liquid tank 57 is sent by the pump 53 with the control valve 52 and the control valve 56 opened. At this time, the gas present in the first storage space 5 is transferred to the cleaning liquid tank 57 through the pipe 54 and is released from an atmosphere opening portion provided in a ceiling of the cleaning liquid tank 57. In addition, in the case where the cleaning liquid is supplied to the first storage space 5, the amount of the hydraulic fluid stored in the second storage space 6 is adjusted depending on the storage amount of the cleaning liquid in the first storage space 5.

It is preferable that the second storage space 6 be filled with the hydraulic fluid, and that a liquid for filling the inside of the first storage space 5 be a liquid such as ultra-pure water in which the concentration of metal ions contained is 1 ppm or less. Immediately before the filling into the first storage space 5, the liquid for filling in the cleaning is filtered through a particle removal filter or the like to remove foreign substances in sizes of several tens of nm or larger. In the cleaning step, the negative-pressure generating member 43 performs pressure control to adjust the pressure in the inter-film gap between the first film 1 and the second film 2 to the same pressure (negative pressure) as in the use of the liquid ejection apparatus 10. In addition, the liquid surface height of the hydraulic fluid 35 in the sub tank 26 is adjusted to a desired position. Thereafter, the storage amount in the state where the first film 1 and the second film 2 are biased to the second storage space 6 side (initial filling state) is measured, and then the cleaning liquid is ejected by the ejection head 14. In this way, the first storage space 5 and the first film 1 are cleaned.

In the cleaning step as above, the pressure in the first storage space 5 is measured by the pressure sensor 55. Then, in a state where the first film 1 and the second film 2 are changed and nearly complete movement from the second storage space 6 side to the first storage space 5 side (ejection material use completion state), the use amount (storage amount) of the ejection material 8 is obtained. In this way, the relationship between the use amount (storage amount) and the pressure is measured multiple times. The measurement information thus obtained is stored in the control unit 36 that performs the liquid surface adjustment of the liquid surface position of the hydraulic fluid 35 in the sub tank 26.

The cleaning step may be performed before the ejection head 14 is attached to the storage container 13. In this case, the information on the relationship between the storage amount and the pressure in the first storage space 5 is obtained by discharging the liquid in the first storage space 5 by the pump 53 with the second opening of the housing 11 sealed, the control valve 56 closed, and the control valve 52 opened.

To perform the cleaning step as above also serves as a break-in operation (aging) for suppressing a reduction and variation in the resistance force of the first film 1 and the second film 2 during movement, and also produces the effect of increasing the use amount of the ejection material in the pressure fluctuation region b1.

In the present embodiment, the control unit 36 obtains the pressure in the first storage space 5 from the measured remaining amount (use amount) of the ejection material 8 in the first storage space 5. Then, the liquid surface height (reference height) of the hydraulic fluid in the sub tank 26 is changed based on the obtained pressure in the first storage space 5 so as to widen the pressure fluctuation region where stable ejection is possible (to increase the usable amount of the ejection material). This may be rephrased as changing the water head difference (water head difference change).

Since the liquid surface height of the hydraulic fluid 35 in the sub tank 26 also varies within a range of ±4 mm, at most 8 mm, a change in the water head pressure, at most 0.08 kPa, occurs in the first storage space 5. In a case where the liquid surface height of the hydraulic fluid 35 in the sub tank 26 is changed to increase the usable amount of the ejection material, it is preferable to consider a variation of the liquid surface height.

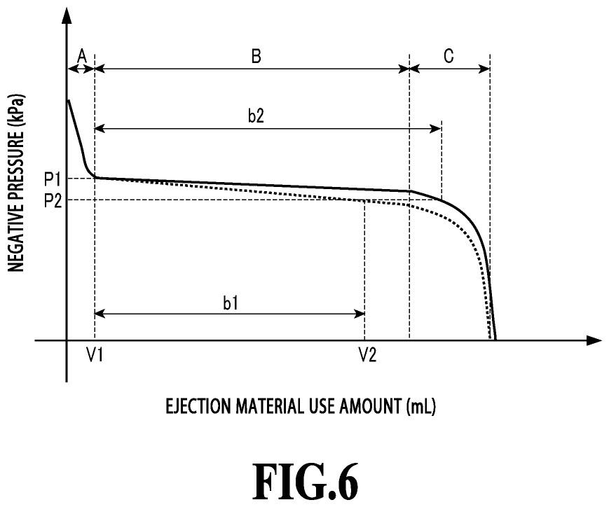

FIG. 6 is a chart of a characteristic curve of a negative pressure generated in the first storage space 5. In the liquid ejection apparatus 10 in the present embodiment, the liquid surface height of the hydraulic fluid 35 in the sub tank 26 is raised as appropriate based on the information on the relationship between the remaining amount of the ejection material 8 and the pressure in the first storage space 5 obtained in advance so that the pressure fluctuation gradient in the pressure fluctuation region B is gentle (see a solid line in FIG. 6). Specifically, in the case where the liquid surface height of the hydraulic fluid 35 in the sub tank 26 falls outside the predetermined range, the liquid surface height of the hydraulic fluid 35 in the sub tank 26 is changed based on the remaining amount of the ejection material 8 in the first storage space 5 at that time.

As a result, as presented in FIG. 6, since the water head pressure is raised with the rise of the liquid surface height, the negative pressure generated in the first storage space 5 can be weakened. Thus, stable ejection can be performed with an ejection material usable region widened to a region b2, as compared with an ejection material usable region b1 in the case without changing the liquid surface height of the hydraulic fluid 35 in the sub tank 26 as depicted by a dashed line in FIG. 6.

The present embodiment describes the example where the water head difference is changed by changing the liquid surface height in the sub tank 26, but an embodiment is not limited to this example. The embodiment may employ a structure that changes the water head difference by changing the position (height) of the sub tank 26.

The ejection method according to the present embodiment is suitable to manufacture articles including, for example, microdevices such as semiconductor devices, elements having fine structures, and so on. In addition, the ejection method according to the present embodiment includes a pattern formation step of forming a pattern on a substrate with an imprint apparatus by bringing a mold into contact with a resin on the substrate. Further, a manufacturing method may include other known steps of treating the substrate with the pattern formed (such as oxidation, film formation, vapor deposition, doping, planarization, etching, resist removal, dicing, bonding, and packaging).

The ejection method in the present embodiment is advantageous over the method in the related art in terms of at least one of the performance, quality, productivity, and production cost of articles manufactured.

As described above, in the course of use of the ejection material, the water head difference (reference height) between the ejection port face and the liquid surface of the hydraulic fluid 35 in the sub tank 26 is changed. According to this, it is possible to provide a liquid ejection apparatus, an imprint apparatus, and an ejection method capable of obtaining a favorable ejection state.

### Second Embodiment

Hereinafter, a second embodiment of the present invention will be described with reference to the drawings. Since the basic structure of the present embodiment is the same as that of the first embodiment, a characteristic structure will be described below.

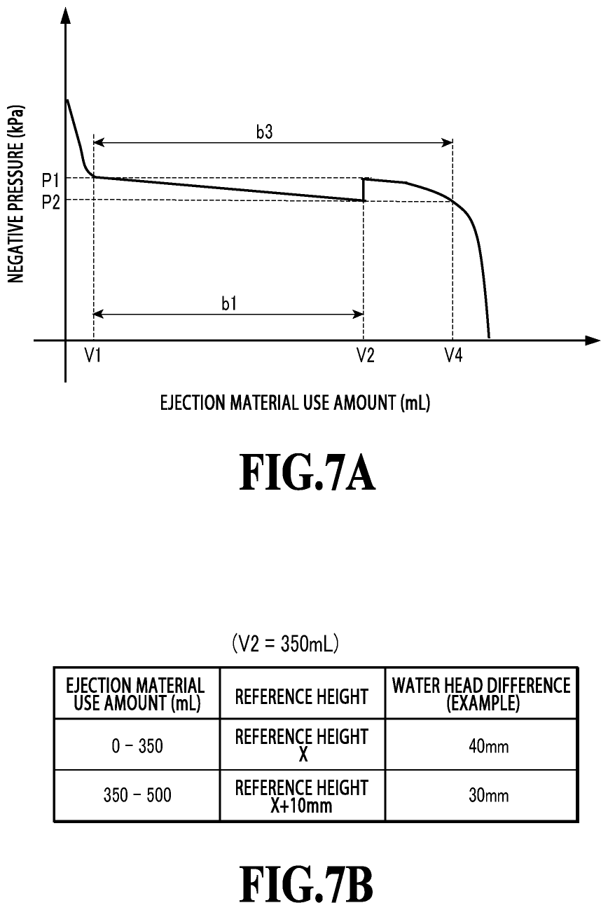

FIG. 7A is a chart of a characteristic curve of a negative pressure generated in the first storage space 5 in the present embodiment. The liquid ejection apparatus 10 in the present embodiment is different from that in the first embodiment in timing for raising the liquid surface height of the hydraulic fluid 35 in the sub tank 26.

In the liquid ejection apparatus 10 in the present embodiment, the ejection of the ejection material 8 is started in a state with a pressure P1 at a position V1 in a pressure fluctuation region b1, and the liquid surface height of the hydraulic fluid 35 in the sub tank 26 is raised in a case where the pressure reaches a pressure P2 at an end position V2 of the pressure fluctuation region b1. In the present embodiment, as presented in FIG. 7B, the reference height (40 mm) is raised by 10 mm and the water head difference ΔH is changed to 30 mm. As a result, the pressure in the first storage space 5 returns to P1.

Thus, even after the use amount of the ejection material 8 reaches the end position V2 of the pressure fluctuation region b1, the pressure in the first storage space 5 is within the pressure fluctuation region where stable ejection is possible. This makes it possible to widen a use region of the ejection material 8 to b3 and accordingly to increase the ejection material use amount to V4. In the present embodiment, the liquid surface height of the hydraulic fluid 35 in the sub tank 26 is changed only once (one change) in a period when the ejection material 8 is used (a period when the ejection of the ejection material 8 under appropriate pressure is possible). This makes it possible to minimize a time period (downtime) when the ejection is suspended in order to change the liquid surface height.

The amount of rise in the liquid surface height is not limited to the amount corresponding to the pressure difference of the pressure P1−the pressure P2, and the liquid surface height may be changed to any height corresponding to the pressure difference of P1−P2 or less so that the pressure in the first storage space 5 after the rise of the liquid surface height is the pressure P1 or lower.

### Third Embodiment

Hereinafter, a third embodiment of the present invention will be described with reference to the drawings. Since the basic structure of the present embodiment is the same as that of the first embodiment, a characteristic structure will be described below.

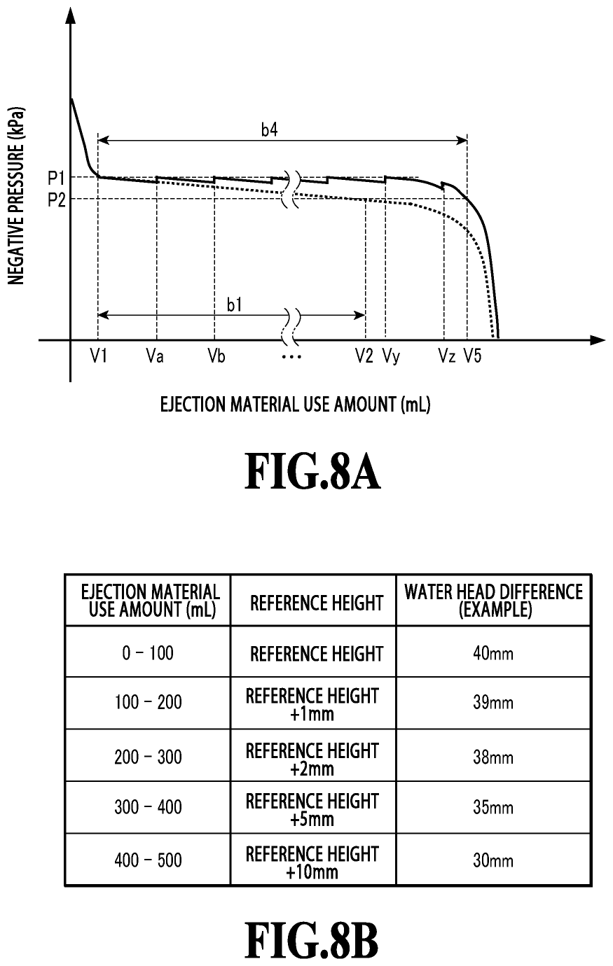

FIG. 8A is a chart of a characteristic curve of a negative pressure generated in the first storage space 5 in the present embodiment. The liquid ejection apparatus 10 in the present embodiment is different from those in the first and second embodiments in timing of raising the liquid surface height of the hydraulic fluid 35 in the sub tank 26.

In the liquid ejection apparatus 10 in the present embodiment, the ejection of the ejection material 8 is started in a state with a pressure P1 at a position V1 in a pressure fluctuation region b1. Then, in a case where an ejection material use amount reaches a position Va by which a certain amount (predetermined amount) of the ejection material 8 is ejected (ejection of the predetermined amount), the liquid surface height of the hydraulic fluid 35 in the sub tank 26 is raised so that the pressure in the first storage space 5 returns to the pressure P1. After that, in a case where the ejection material use amount reaches Vb (Va−V1=Vb−Va holds) from the amount Va, the liquid surface height of the hydraulic fluid 35 in the sub tank 26 is again raised so that the pressure in the first storage space 5 returns to the pressure P1. The same operation is repeated until the ejection material use amount reaches Vz. This makes it possible to widen the pressure fluctuation region where stable ejection is possible to b4 and accordingly to increase the ejection material use amount to V5.

In the present embodiment, every time the use amount of the ejection material 8 reaches the certain amount (predetermined amount), the liquid surface height of the hydraulic fluid 35 in the sub tank 26 is changed as described above. As explained using FIG. 4, the relationship between the pressure in the first storage space 5 and the use amount of the ejection material 8 changes nearly linearly in the pressure fluctuation region B started from the use start position V1 of the ejection material 8. Accordingly, the tendency of the pressure change after the liquid surface height of the hydraulic fluid 35 in the sub tank 26 is raised until the liquid surface height is raised next time is almost constant. Moreover, since a state with small pressure fluctuations can be maintained in a period from V1 to Vy, it is possible to reduce variations in ejection performances such, for example, as an ejection speed and an ejection amount.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-143168 filed Sep. 8, 2022, which is hereby incorporated by reference wherein in its entirety.

What is claimed is:

1. A liquid ejection apparatus comprising:
an ejection head having an ejection port face in which an ejection port configured to eject an ejection material is formed;
a storage container including a first storage space that stores the ejection material and communicates with the ejection head, and a second storage space that is separated from the first storage space by a flexible member and stores a hydraulic fluid;
a sub tank that communicates with the second storage space and is capable of supplying the hydraulic fluid to the second storage space;
a main tank that is capable of supplying the hydraulic fluid to the sub tank, in which the ejection port face is arranged at a position higher than a liquid surface of the hydraulic fluid in the sub tank; and
a water head difference change unit that changes heights of the ejection port face and the liquid surface of the hydraulic fluid in the sub tank along with ejection of the ejection material from the ejection port.

2. The liquid ejection apparatus according to claim 1, wherein the water head difference change unit changes the height of the liquid surface of the hydraulic fluid in the sub tank by supplying the hydraulic fluid from the main tank to the sub tank.

3. The liquid ejection apparatus according to claim 1, further comprising a storage unit that stores a relationship between a pressure in the first storage space and an amount of the ejection material ejected from the ejection port.

4. The liquid ejection apparatus according to claim 3, further comprising an obtaining unit that obtains an amount of the ejection material ejected from the ejection port, wherein
the water head difference change unit changes the height of the liquid surface of the hydraulic fluid in the sub tank based on the amount of the ejection material obtained by the obtaining unit and the relationship between the pressure in the first storage space and the amount of the ejection material ejected from the ejection port stored in the storage unit.

5. The liquid ejection apparatus according to claim 1, wherein
in a case where a storage amount in the first storage space changes and reaches a liquid storage amount with which the pressure in the first storage space falls outside a predetermined range, the water head difference change unit changes the height of the liquid surface of the hydraulic fluid in the sub tank so that the pressure in the first storage space becomes within the predetermined range.

6. The liquid ejection apparatus according to claim 5, wherein
in a period when ejection of the ejection material in the first storage space under appropriate pressure is possible, the water head difference change unit changes the height of the liquid surface of the hydraulic fluid in the sub tank once.

7. The liquid ejection apparatus according to claim 5, wherein
in response to ejection of a predetermined amount of the ejection material in the first storage space from the ejection port, the water head difference change unit changes the height of the liquid surface of the hydraulic fluid in the sub tank.

8. The liquid ejection apparatus according to claim 1, wherein the sub tank includes a liquid surface detection unit that detects the liquid surface.

9. The liquid ejection apparatus according to claim 1, wherein the flexible member includes a first film that forms a part of the first storage space and a second film that forms a part of the second storage space.

10. The liquid ejection apparatus according to claim 1, wherein the ejection material is an imprint material that is a resist made of a thermosetting resin.

11. A liquid ejection apparatus comprising:
an ejection head having an ejection port face in which an ejection port configured to eject an ejection material is formed;
a storage container including a first storage space that stores the ejection material and communicates with the ejection head, and a second storage space that is separated from the first storage space by a flexible member and stores a hydraulic fluid;
a sub tank that communicates with the second storage space and is capable of supplying the hydraulic fluid to the second storage space; and
a main tank that is capable of supplying the hydraulic fluid to the sub tank, wherein
the ejection port face is arranged at a position higher than a liquid surface of the hydraulic fluid in the sub tank; and
a height of the liquid surface of the hydraulic fluid in the sub tank is changed based on a pressure in the first storage space corresponding to a deformation amount of the flexible member deformed.

12. An imprint apparatus comprising:
a liquid ejection unit including
an ejection head having an ejection port face in which an ejection port configured to eject an ejection material is formed,
a storage container including a first storage space that stores the ejection material and communicates with the ejection head, and a second storage space that is separated from the first storage space by a flexible member and stores a hydraulic fluid,
a sub tank that communicates with the second storage space and is capable of supplying the hydraulic fluid to the second storage space, and
a main tank that is capable of supplying the hydraulic fluid to the sub tank;
a pattern formation unit that forms a pattern corresponding to an uneven pattern of a mold, in which the ejection port face is arranged at a position higher than a liquid surface of the hydraulic fluid in the sub tank; and
a water head difference change unit that changes heights of the ejection port face and the liquid surface of the hydraulic fluid in the sub tank along with ejection of the ejection material from the ejection port.

13. An ejection method comprising:
ejecting an ejection material from an ejection port formed in an ejection port face of an ejection head;
storing the ejection material into a first storage space that communicates with the ejection head and storing a hydraulic fluid into a second storage space separated from the first storage space by a flexible member;
supplying the hydraulic fluid to the second storage space from a sub tank that communicates with the second storage space;
supplying the hydraulic fluid to the sub tank from a main tank; and
arranging the ejection port face at a position higher than a liquid surface of the hydraulic fluid in the sub tank, wherein
heights of the ejection port face and the liquid surface of the hydraulic fluid in the sub tank are changed along with ejection of the ejection material from the ejection port.
